(19) United States
(12) Patent Application Publication
(10) Pub. No.: US 2018/0052671 A1
(43) Pub. Date: Feb. 22, 2018

(54) SYSTEM AND METHOD TO CONTROL HYBRID DEPLOYMENT OF AN APPLICATION

(71) Applicant: HCL Technologies Limited, Uttar Pradesh (IN)

(72) Inventors: Rajesh Venkatesan, Tamil Nadu (IN); Sezhiyan Navarasu, Tamil Nadu (IN); Madhava Venkatesh Raghavan, Tamil Nadu (IN)

(21) Appl. No.: 15/662,795

(22) Filed: Jul. 28, 2017

(30) Foreign Application Priority Data
Aug. 19, 2016 (IN) 201611028348

(51) Int. Cl. G06F 9/445; G06F 9/44; G06F 21/62; H04L 29/08

(52) U.S. Cl. CPC G06F 8/60; G06F 8/71; H04L 67/10; H04L 67/34; G06F 21/629

(57) ABSTRACT

The system and method to control hybrid deployment of an application is disclosed. The method comprises receiving an application developed utilizing an application archetype and further deploying the application in a hybrid deployment. The hybrid deployment comprises of cloud datacenter deployment and local datacenter deployment. The method further comprises obtaining a configuration data dynamically at runtime associated with primary and secondary configuration data. The primary configuration is associated with the cloud datacenter and the secondary configuration is associated with the local datacenter deployment. The method further more comprises storing the configuration data as a metadata in the application archetype. Further, based on metadata, the access to the functionalities of the application are allowed or denied, thereby controlling the hybrid deployment of an application.

### CROSS-REFERENCE TO RELATED APPLICATIONS AND PRIORITY

The present application claims priority from Indian Patent Application no. 201611028348 filed on 19 Aug. 2016, the entirety of which is hereby incorporated by reference.

### TECHNICAL FIELD

The present invention in general relates to the hybrid deployment of an application. More particularly, the present invention relates to a method and system for controlling a functionality of an application in a hybrid deployment.

### BACKGROUND

Generally, software service providers build software based on the requirement of their customers. These software maybe deployed in cloud datacentre or local datacentre of the customer. Software deployed in cloud datacentre may be used to service multiple customers from the same deployment using multi tenancy techniques. However, the software is required to be customized and differentiated based on the geographic conditions, individual needs and on the like.

Typically, there are multiple conventional models for building and deploying the software. One of the examples of conventional models may be building a single software from a single code base and the same deployment is used to service multiple customers. Other conventional model may be a software built by extending the single code based and customizing based on the customer requirements, deployed separately for each customer.

The conventional models used for building and deployment of the software are either very complex leading to increase in cost. At same time, deploying such a complex software further leads to increase in issues with ownership of the software.

Moreover in certain circumstances, during the development of the software it is unknown whether the software is going to be used from cloud datacentre and/or local datacentre or both. This may be due to restricted internet access or security or regulatory reasons of the customer. Hence, conventional models fail to facilitate developing of a software that could be deployed and accessed from cloud datacentre and/or local datacentre or both.

### SUMMARY

Before the present a method and system for controlling a functionality of an application in a hybrid deployment, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular implementations or versions or embodiments only, and is not intended to limit the scope of the present application. This summary is provided to introduce aspects related to a method and system for controlling a functionality of an application in a hybrid deployment. This summary is not intended to identify essential features of the claimed subject matter nor is it intended for use in determining or limiting the scope of the claimed subject matter.

In one implementation, a method for controlling a functionality of an application in a hybrid deployment is disclosed. In one aspect, the method may comprise receiving an application developed utilizing an application archetype. The application archetype enables abstraction of one or more complexities of developing the application. The application archetype comprises of one or more of build and package feature, a multi tenancy feature, a data access feature, a customization feature, a security feature, a user interface feature and a synchronization feature. The application is developed by a developer. Further the method may comprise, deploying the application in a hybrid deployment. The hybrid deployment comprises a cloud datacentre deployment and a local datacentre deployment. Further the method may comprise, obtaining a primary configuration data associated with the cloud datacentre deployment and a secondary configuration data associated with the local datacentre deployment. The primary configuration data and the secondary configuration data is obtained dynamically at runtime from one or more users of the application. The primary configuration data and secondary configuration data comprises one or more of functionality, a write operation and a data synchronization. Further the method may comprise, storing, the primary configuration data and the secondary configuration data as a metadata in the application archetype. Further, the method may comprise, controlling one or more functionality of the application, at runtime, based on metadata.

In one implementation, a system for controlling a functionality of an application in a hybrid deployment is disclosed. In one aspect, the system comprises a memory and a processor coupled to the memory. Further, the processor may be capable of executing instructions in the memory to perform one or more steps. In the aspect, the system may comprise receiving an application developed utilizing an application archetype. The application archetype enables abstraction of one or more complexities of developing the application. The application archetype comprises one or more of a build and package feature, a multi tenancy feature, a data access feature, a customization feature, a security feature, a user interface feature and a synchronization feature. The application is developed by a developer. Further, the system may comprise, deploying the application in a hybrid deployment, wherein the hybrid deployment comprises a cloud datacentre deployment and a local datacentre deployment. Further the system may comprise, obtaining a primary configuration data associated with the cloud datacentre and a secondary configuration data associated with the local datacentre deployment. The primary configuration data and the secondary configuration data is obtained dynamically at runtime from one or more users of the application that comprises one or more of functionality, a write operation and a data synchronization. Further the system may comprise, storing, the primary configuration data and the secondary configuration data as a metadata in the application archetype. Further the system may comprise, controlling one or more functionality of the application, at runtime based on metadata.

In yet another implementation, non-transitory computer readable medium embodying a program executable in a computing device for controlling a functionality of an application in a hybrid deployment is disclosed. In one aspect, the program may comprise a program code for receiving an application developed utilizing an application archetype. Further, the application archetype may enables abstraction of one or more complexities of developing the application. The application archetype comprises one or more of a build and package feature; a multi tenancy feature, a data access feature, a customization feature, a security feature, a user interface feature and a synchronization feature. The application is developed by a developer. The program may comprise a program code for deploying the application in a hybrid deployment. The hybrid deployment comprises a cloud datacentre deployment and a local datacentre deployment. The program may comprise a program code for obtaining a primary configuration data associated with the cloud datacentre deployment and a secondary configuration data associated with the local datacentre deployment. The primary configuration data and the secondary configuration data may be obtained dynamically at runtime from one or more users of the application. The configuration data comprises one or more of functionality, a write operation and a data synchronization. The program may comprise a program code for storing the primary configuration data and the secondary configuration data as a metadata in the application archetype. Further, the program may comprise a program code for controlling one or more functionality of the application, at runtime, based on metadata.

### BRIEF DESCRIPTION OF DRAWINGS

The foregoing detailed description of embodiments is better understood when read in conjunction with the appended drawings. For the purpose of illustrating of the present subject matter, an example of construction of the present subject matter is provided as figures; however, the invention is not limited to the specific method and system disclosed in the document and the figures.

The present subject matter is described detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network implementation of a system for controlling a functionality of an application in a hybrid deployment, in accordance with an embodiment of the present subject matter.

FIG. 2 illustrates a block diagram of an application archetype, in accordance with an embodiment of the present subject matter.

FIG. 3 illustrates system and its subcomponents for controlling a functionality of an application in a hybrid deployment, in accordance with an embodiment of the present subject matter.

FIG. 4 illustrates a flow diagram for controlling a functionality of an application in a hybrid deployment, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods for controlling a functionality of an application in a hybrid deployment, similar or equivalent to those described herein can be used in the practice or testing of embodiments of the present disclosure, the exemplary, systems and methods for controlling a functionality of an application in a hybrid deployment are now described. The disclosed embodiments for controlling a functionality of an application in a hybrid deployment are merely examples of the disclosure, which may be embodied in various forms.

Various modifications to the embodiment will be readily apparent to those skilled in the art and the generic principles herein may be applied to other embodiments for controlling a functionality of an application in a hybrid deployment. However, one of ordinary skill in the art will readily recognize that the present disclosure for controlling a functionality of an application in a hybrid deployment is not intended to be limited to the embodiments described, but is to be accorded the widest scope consistent with the principles and features described herein.

In an implementation, systems and methods for controlling a functionality of an application in a hybrid deployment, is disclosed. In the implementation, an application developed utilizing an application archetype is received. The application archetype may be a set of pre-built functionalities available for use to the application developer. The application developer may develop the business specific functionalities using archetype and on top of the common cross cutting functionalities provided by the archetype. Commonly considered functionalities of an application development that determine the software to be developed are multi-tenancy, data access, controlling read-write operation for data, controlling data synchronization, configuration and customization for the customer like workflows, reports, security authentication and packaging. The application archetype is used to build single software with an option to selectively be accessed by the user from cloud datacentre or local datacentre.

In the implementation, upon receiving the application, the application is deployed in a hybrid deployment. Further, the hybrid deployment comprises a cloud datacentre deployment and a local datacentre deployment. Subsequent to deployment, primary configuration data associated with the cloud datacentre deployment and secondary configuration data associated with the local datacentre deployment is obtained and stored as metadata. Further, the primary configuration and the secondary configuration data may be configured at runtime after the application is deployed and updated according to one or more users of the application such as onboarded customer requirements. The application archetype manages the primary configuration and the secondary configuration data based on per customer and per deployment model. The primary configuration data and the secondary configuration data may include but not limited to extensions—new fields at runtime, field validations, rules, workflows, reports, user interface (UI) layout and themes, authentication for users of the customer, list of functionalities accessible to the user in cloud datacentre and/or local datacentre.

Further to storing the primary configuration data and the secondary configuration data as metadata in the application archetype, the user may access the functionality from cloud datacentre and/or local datacentre. If the functionality is enabled for the user for the current mode of deployment—cloud datacentre or local datacentre the user may continue to access the functionality else the access would be denied to the user. Thus, controlling the functionality of an application in a hybrid deployment of an application.

In one implementation, the synchronization of the data may be triggered by the application archetype based on the functionality configuration stored as metadata. Additionally, write operation for a user may be based on the functionality configuration stored as metadata.

While aspects of described system and method for controlling hybrid deployment of an application may be implemented in any number of different computing systems, environments, and/or configurations, the embodiments are described in the context of the following exemplary system.

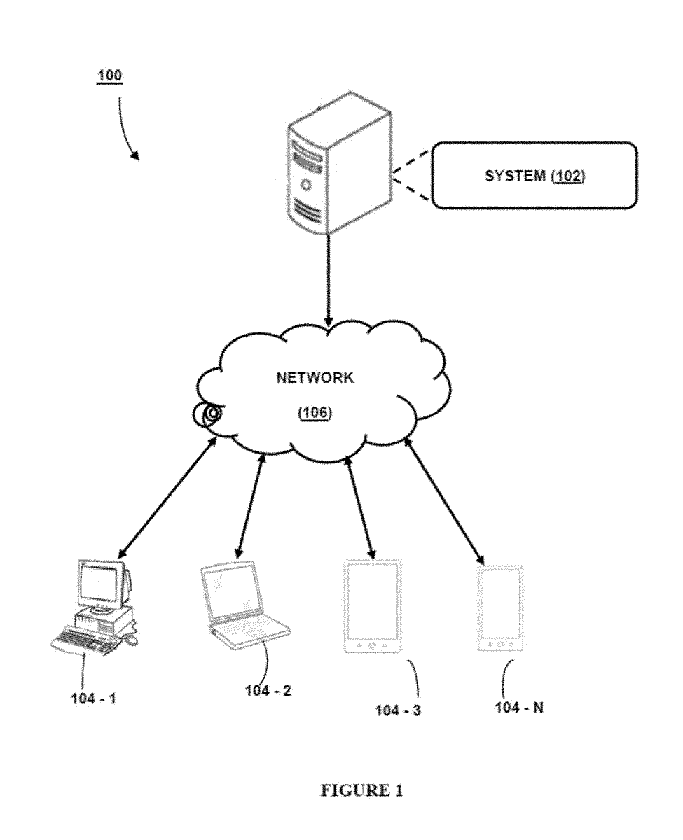

Referring now to FIG. 1, a network implementation (100) of a system (102) for hybrid deployment of an application is disclosed. In one implementation, the system (102) may receive an application developed utilizing an application archetype. The system (102) may further, enable deployment of the application through a network (106). in a hybrid deployment wherein the hybrid deployment comprises a cloud datacentre deployment and a local datacentre deployment. Further, the system (102) obtains and stores as metadata the primary configuration data and the secondary configuration data comprising one or more of functionality, a write operation and a data synchronization obtained at runtime from the user of the application. The system (102) is thus enabled to control the one or more functionality of the application, at runtime, based on metadata. Although the present subject matter is explained considering that the system (102) is implemented on a server, it may be understood that the system (102) may also be implemented in a variety of computing systems, such as a laptop computer, a desktop computer, a notebook, a workstation, a mainframe computer, a server, a network server, and the like.

In one implementation, the system (102) may be implemented in a cloud-based environment in which the user may operate individual computing systems configured to execute remotely located applications. In another embodiment, the system (102) may also be implemented on customer devices, hereinafter referred to as a customer device (104). It may be understood that the system implemented on the customer device supports a plurality of browsers and all viewports. It will also be understood that the system (102) may be accessed by multiple users of the customer through one or more user devices 104-1, 104-2 . . . and 104-N, collectively referred to as user devices (104) hereinafter, or applications residing on the user devices (104). Examples of the user devices (104) may include, but are not limited to, such as a laptop computer, a desktop computer, a notebook, a workstation, a main frame computer, a server, a network server, a cloud-based computing environment and the like. The user devices (104) are communicatively coupled to the system (102) through a network (106).

In one implementation, the network (106) may be a wireless network, a wired network or a combination thereof. The network (106) can be implemented as one of the different types of networks, such as intranet, local area network (LAN), wide area network (WAN), the Internet, and the like. The network (106) may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network (106) may include a variety of network devices, including routers, bridges, servers, computing devices, storage devices, and the like.

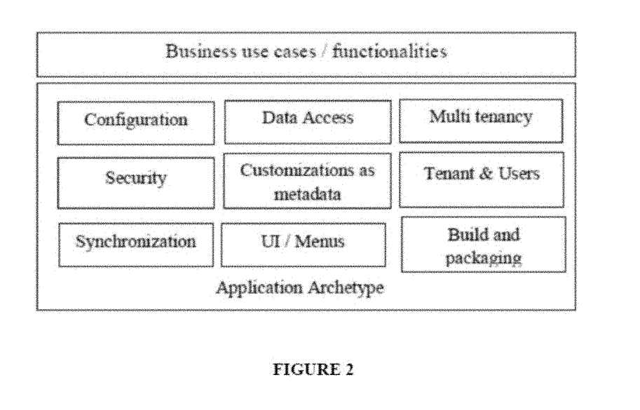

Referring now to FIG. 2, block diagram of an application archetype, in accordance with an embodiment of the present subject matter is illustrated. In one example the application includes one or more functionalities of an application development. The application comprise of functionalities which may be multi tenancy, data access, configuration, customization, user interface, synchronization, security and packaging.

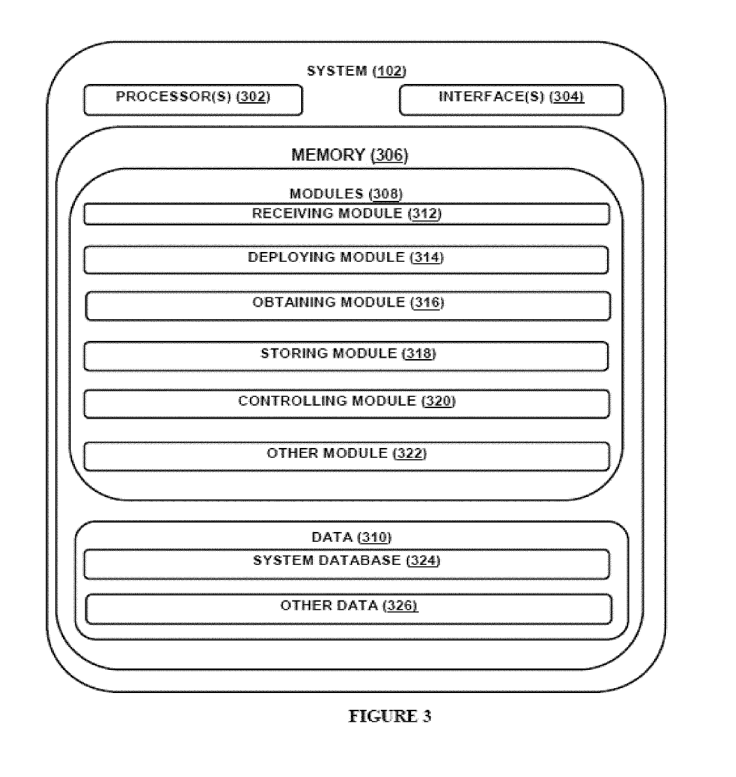

Referring now to FIG. 3, the system (102) is illustrated in accordance with an embodiment of the present subject matter. In one embodiment, the system (102) may include at least one processor (302), an input/output (I/O) interface (304), and a memory (306). The at least one processor (302) may be implemented as one or more microprocessors, microcomputers, microcontrollers, digital signal processors, central processing units, state machines, logic circuitries, and/or any devices that manipulate signals based on operational instructions. Among other capabilities, the at least one processor (302) is configured to fetch and execute computer-readable instructions stored in the memory (306).

The I/O interface 304 may include a variety of software and hardware interfaces, for example, a web interface, a graphical user interface, and the like. The I/O interface (304) may allow the system (102) to interact with a user directly or through the user devices (104). Further, the I/O interface (304) may enable the system (102) to communicate with other computing devices, such as web servers and external data servers (not shown). The I/O interface (304) can facilitate multiple communications within a wide variety of networks and protocol types, including wired networks, for example, LAN, cable, etc., and wireless networks, such as WLAN, cellular, or satellite. The I/O interface (304) may include one or more ports for connecting a number of devices to one another or to another server.

The memory (306) may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory (306) may include modules (308) and data (310).

The modules (308) include routines, programs, objects, components, data structures, etc., which perform particular tasks, functions or implement particular abstract data types. In one implementation, the modules (308) may include a receiving module (312), a deploying module (314), an obtaining module (316), a storing module (318), a controlling module (320), and other modules (322). The other modules (322) may include programs or coded instructions that supplement applications and functions of the system (102).

The data (310), amongst other things, serves as a repository for storing data processed, received, and generated by one or more of the modules (308). The data (310) may also include a system database (324), and other data (326). The system database (324) is configured to store the primary configuration data associated with the cloud datacentre deployment and secondary configuration data associated with the local datacentre deployment.

### Receiving Module (312)

In one implementation, the receiving module (312) may receive an application developed utilizing an application archetype. An application so obtained may be understood as application that allows an user to perform associated tasks and activities.

In one embodiment, the application archetype may be understood as an application development template with a set of pre-built functionalities available for use to an application developer. The application developer may use the application archetype to develop application that may be deployed both in cloud datacentre and local datacentre and can be accessed by the user either from cloud datacentre and local datacentre. The application archetype may comprise of build and package functionalities. In one embodiment, single application archetype maybe used to build a single software application. The application archetype may provide output of two artefacts one for cloud datacentre deployment and one for local datacentre deployment. In one implementation, the cloud datacentre artefact packaging may add the implementations meant only for the cloud datacentre and remove the implementations meant for local datacentre. In other implementation, the local datacentre artefact packaging may add the implementations meant for the local datacentre and remove the implementations meant only for cloud datacentre. Further, the packaging may add all the resources or the resources associated with the functionality applicable for individual deployment.

In one embodiment, the application archetype may allow the application developer to register the list of functionalities developed using the archetype and the set of resources associated with that functionality. The application archetype enables the application to identify the functionality to be enabled in cloud datacentre and in local datacentre.

In one embodiment, the application archetype may expose Application Program Interface (API) to access data from the database. In one implementation available API may be one or more of DataAccess.create (data), DataAccess.get (data_id), DataAccess.get (filter), DataAccess.update (data), DataAccess.delete (data_id), DataAccess.execute (query). Further, the API may validate the data, data isolation per customer and determine whether the application is required to be deployed one for cloud datacentre or for local datacentre. Implementation for cloud datacentre or for local datacentre may be stubbed during packaging.

In another implementation, for every functionality several resources may be added to the application that may constitute a single functionality, where such functionality may not be limited to domain/data models, menus, business services, UI resources and access permission. In one implementation, the developer may define the functionality by defining the resources being utilized by functionality through an xml configuration. In an exemplary embodiment, the functionality of ‘Add User’ maybe considered to understand the configuration and customization of the customer. ‘Add User’ user interface may capture basic information like username, first name, last name etc. The functionality through an XML configuration maybe as:

<functionalities>

<functionality name=″User Management″>
<menus>

<menu name=″Add User″/>
<menu name=″List User″/>

```
  <menus>
  <datamodels>
```

<datamodel name=″User″/>
<datamodel name=″Roles″/>

```
  </datamodels>
  <services>
```

<service name=″UserServiceImplementation″/>
<service name=″CustomerServiceImplementation″/>

```
  </services>
  <urls>
```

<url path=″/user/add″/>
<url path=″/users″/>

```
  </urls>
  <permissions>
```

<permission name=”ADD_USER”>

```
    <permission name=”DELETE_USER”>
  <permissions>
</functionality>
```

</functionalities>

In a further exemplary embodiment, the functionality of ‘Add User’ maybe configured to capture any additional information required by the customer. The customer may add a new field such as ‘mobile number’ to be captured additional to the existing information that maybe further stored as metadata for the entity ‘User’ for the customer and for the deployment model. Thus, if the customer attempts to add a user, the application may check using the metadata API for any additional fields configured for the customer and the mode of deployment i.e. cloud datacentre or local datacentre. If there are any additional fields, the fields maybe shown on the user interface. Upon receiving the valid inputs from the user, the application may utilize the data access API to save the user information along with the additional field information captured for the user. In one implementation, the customization maybe extended to other fields like workflows, rules, reports etc.

In another embodiment, the application archetype may further contain features or facets such as multi tenancy, data access, configuration, customization, user interface, menus, synchronization and authentication. In one example, multi tenancy maybe understood as an architecture in which a single instance of an application may run on a server and serve multiple customers.

In further embodiment, the application archetype enables abstraction of one or more complexities of developing the software. The application developer is abstracted from developing a separate application for cloud datacentre and local datacentre. In one example, application archetype my abstract the complexities of the application developer by gathering and storing the customizations of the customer along with the variations between the cloud datacentre and the local datacentre as metadata. The metadata stores configurations for each customer and for each deployment model. The customer may after deployment of a hybrid application configure how the application should behave for the users in cloud datacentre and in local datacentre.

In further implementation, the user authentication functionality maybe based on the customer configurations. These configurations may be different between cloud datacentre deployment and local datacentre deployment. To provide authentication each user may be associated to a set of roles aggregating permissions to execute application functionalities. Each application functionality may be mapped to a single or a set of permissions, thus allowing users with the permission to access the application functionality or the resources associated with the functionality. In one example, each user of the application maybe identified uniquely using the username and the customer to which the user is associated with. Further, each customer may have their own authentication mechanism where such authentication maybe token based or active directory or Security Assertion Markup Language (SAML) based identity provider or oauth authentication. The customer configuration maybe different between cloud deployment and datacentre deployment. The one or more users may be associated with the customer.

Further, the receiving module (312) may receive an application developed utilizing an application archetype that may be used to build a single application. In the implementation, upon receiving, the receiving module (312) may store the received information in system database (324).

### Deploying Module (314)

In one implementation, the deploying module (314) may deploy the application in a hybrid deployment. The hybrid deployment may comprise of a cloud datacentre deployment and a local datacentre deployment.

In one implementation, the application may be deployed in cloud datacentre only. In another implementation, the application maybe deployed in local datacentre only. Further, in another implementation wherein no preference is received from the customer the application is deployed in the cloud datacentre and when the request is provided the local deployment may be initiated.

In one implementation, the functionality to be enabled in cloud data centre and the local datacentre maybe based on the application developed utilizing the application archetype. The selective enablement of the functionalities maybe through a set of configurations specified at runtime made during the deployment of the application for a customer. Further, in one example, same application maybe hosted for multiple customers.

### Obtaining Module (316)

In one implementation, the obtaining module (316) may obtain primary configuration data associated with the cloud datacentre deployment and the secondary configuration data associated with the local datacentre deployment. The primary configuration data and secondary configuration data are obtained dynamically at runtime that may comprise one or more of functionality, write operation and data synchronization. The customizations of the customer may include but not limited to field extensions, field validations, rules, workflows, reports, user interface layouts and themes, user authentication and the functionalities accessible in cloud datacentre and local datacentre to the one or more users associated with a customer. Further the customizations may become the metadata API related to the customer.

In one embodiment, the customizations of the customer obtained at runtime maybe modified according to the requirement of the customer. These customizations maybe stored as metadata in system database (326).

During onboarding of the customer the obtaining module (316) allows the customer to customize the application based on a deployment mode. The deployment mode may be cloud datacentre or local datacentre or both. The well-defined API related to the customer may manage the customizations of the customer as a metadata to be enabled to identify whether the deployment is for cloud datacentre or local datacentre. The application archetype manages the customizations based on per customer and per deployment model.

In one implementation, the obtaining module (316) prompts the customer to list the one or more of a functionality to be enabled. In one implementation, the application may be enabled in cloud datacentre. In another implementation, the application may be enabled in local centre. In further implementation, the application may be enabled in both cloud datacentre and local datacentre. The functionality to be enabled may be one or more of but not limited to user management, password policy management, department management, role management, user interface customization, workflow customization and report customization. In one implementation, the information obtained from the customer may be stored as a customization metadata. In an example, the customer may be facilitated to list functionality to be enabled in the following manner:

| Functionality | Enable in Datacentre | Enable in cloud |
|---|---|---|
| User management | Yes | Yes |
| Password policy management | Yes | Yes |
| Department Management | No | Yes |
| Customization of UI | No | Yes |
| Customization of Workflows | No | Yes |
| Customization of Reports | No | Yes |
| Customer Management | No | Yes |
| Roles Management | Yes | Yes |

In one implementation, the customer may selectively choose whether the data may be written in cloud datacentre or local datacentre or both for an identified user of the customer. The module provides the ability to choose the data access API to manage data. Once the application is deployed, the customer may be prompted to choose the data access for all user roles.

In one implementation, the application archetype may provide an ability to control and synchronize the data between cloud datacentre and the local datacentre. In one example, data synchronized to local datacentre may only belong to the customer for whom local datacentre deployment is opted. For other customer's data may not be synchronized.

In one implementation, the customer may selectively choose a data synchronization frequency for cloud datacentre and local datacentre. The synchronization may be based on frequency and the data transfer for synchronization. Further, the synchronization may be based on push from cloud, push from datacentre or pull from the datacentre. In one example, the customer during onboarding maybe prompted for synchronization of data of all data models. Further, the information regarding the synchronization of data is stored as metadata for the customer and per deployment model. Such information may be as below:

| | Datacentre | | | Cloud | | |
|---|---|---|---|---|---|---|
| | (Sync from | | | (Sync from | | |
| Data Model | cloud) | Frequency | | datacentre) | Frequency | |
| User | Yes | 1 | hour | Yes | 10 | minutes |
| Customer | Yes | 1 | hour | No | — | |
| Role | Yes | 10 | mins | Yes | 10 | mins |
| . . . | . . . | | | . . . | | |

In one implementation, the user based on the role access the application from the cloud datacentre or local datacentre or both. In a condition, that the user may access the application from both the cloud datacentre and local datacentre, then different role may be assigned to the user to access the application from cloud datacentre and different role may be assigned to the user to access the application from local datacentre.

### Storing Module (318)

In one implementation, the storing module (320) may store the primary configuration data and the secondary configuration data as a metadata in the application archetype. The application customizations for a customer are stored as metadata in system database (324).

### Controlling Module (320)

In one implementation, the controlling module (322) may control one or more functionality of the application based on the metadata, at runtime. In one exemplary implementation, the user may attempt to access the application from a cloud datacentre. On receiving the user login and the Uniform Resource Locator (URL) the controlling module (320) may determine a deployment type of the application. The deployment type comprises of the cloud datacentre deployment and the local datacentre deployment. Upon checking by the controlling module (320), the controlling module (320) may determine the access to the user for a functionality and/or a write operation based on the metadata stored. The user may access the functionality and/or the write operation if the user has access as stored in the metadata. In one exemplary implementation, the user may not have the access to the functionality and/or the write operation, the access to the user may be denied. In the manner as above the hybrid deployment of the application may be enabled by controlling the functionality of the application.

Exemplary embodiments for controlling a functionality of an application in a hybrid deployment as discussed above may provide certain advantages. Though not required to practice aspects of the disclosure, these advantages may include those provided by the following features.

Some embodiments of the system and the method control hybrid deployment of an application by abstracting one or more complexities of developing the application.

Some embodiments of the system and the method enable hybrid deployment of an application that may selectively be accessed by the user from cloud datacentre or local datacentre.

Some embodiments of the system and the method enable selective controlling of write operations on data between cloud datacentre and local datacentre.

Some embodiments of the system and the method enable selective synchronization of data between cloud datacentre and local datacentre.

Some embodiments of the system and the method enable customization between cloud datacentre and local datacentre using metadata.

Some embodiments of the system and the method enable controlling of the functionalities available in cloud datacentre and local datacentre.

Some embodiments of the system and the method enable controlling the user access between the cloud datacentre and local datacentre.

Some embodiments of the system and the method abstract the complexities of the application developer by storing the changes between the customers and also the changes between cloud datacentre and the local datacentre as metadata which maybe be configured at runtime after the application is deployed and customized as per the requirements of the customer being onboarded.

Some embodiments of the system and the method enable multiple customers to be hosted on same application providing ability to customize the application at runtime after deployment.

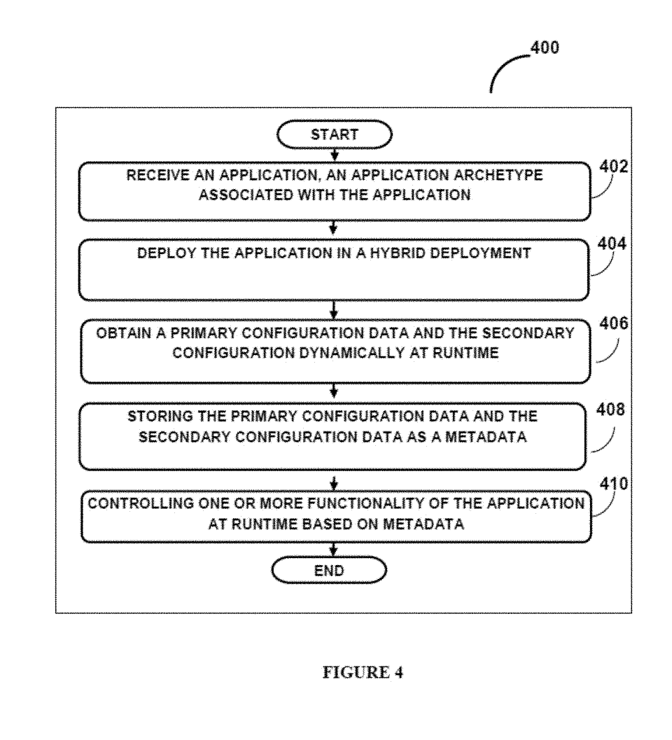

Referring now to FIG. 4, a method (400) to control hybrid deployment of an application that may selectively be accessed by the user from cloud datacentre or local datacentre is disclosed, in accordance with an embodiment of the present subject matter. The method (400) may be described in the general context of computer executable instructions. Generally, computer executable instructions can include routines, programs, objects, components, data structures, procedures, modules, functions, and the like, that perform particular functions or implement particular abstract data types. The method (400) may also be practiced in a distributed computing environment where functions are performed by remote processing devices that are linked through a communications network. In a distributed computing environment, computer executable instructions may be located in both local and remote computer storage media, including memory storage devices.

The order in which the method (400) is described is not intended to be construed as a limitation, and any number of the described method blocks can be combined in any order to implement the method (400) or alternate methods. Additionally, individual blocks may be deleted from the method (400) without departing from the spirit and scope of the subject matter described herein. Furthermore, the method (400) can be implemented in any suitable hardware, software, firmware, or combination thereof. However, for ease of explanation, in the embodiments described below, the method (400) may be considered to be implemented in the above described system (102).

At block (402), an application developed utilizing an application archetype is received. In one example, the application archetype may comprise build and package feature. The application archetype enables abstraction of one or more complexities of developing the application. In one embodiment, the receiving module (312) may receive an application developed utilizing an application archetype and stores the application and the application archetype in system database (324).

At block (404), the primary application in the cloud datacentre and the secondary application in the local datacentre are deployed. In one embodiment, the deploying module (314) is configured to deploy the primary application in the cloud datacentre and the secondary application in the local datacentre and stores the primary application in the cloud datacentre and the secondary application in the local datacentre in system database (324).

At block (406), a primary configuration data associated with the primary application and the secondary configuration data associated with the secondary application is obtained. In one example, configuration data may comprise one or more of but not limited to user management, password policy management, department management, role management, customization of user interface, customization of workflows, and customization of reports. In one embodiment, the obtaining module (316) is configured to obtain a primary configuration data associated with the primary application and the secondary configuration data associated with the secondary application and store the configuration data in system database (324).

At block (408), the primary configuration data associated with the primary application and the secondary configuration data as a metadata is stored in the application archetype. In one embodiment, the storing module (318) is configured to store the primary configuration data associated with the primary application and the secondary configuration data as a metadata in the application archetype and store the configuration data in system database (326).

At block (410), one or more functionality of the application based on metadata, is controlled. In one embodiment, the controlling module (322) is configured to obtain one or more functionality of the application based on metadata and enable a hybrid deployment of an application.

Exemplary embodiments discussed above may provide certain advantages. Though not required to practice aspects of the disclosure, these advantages may include a method and system for controlling a functionality of an application in a hybrid deployment.

Although implementation for methods and systems to enable hybrid deployment of an application has been described, it is to be understood that the appended claims are not necessarily limited to the specific features or methods described. Rather, the specific features and methods are disclosed as examples of implementations to enable hybrid deployment of an application that may selectively be accessed by the user from cloud datacentre or local datacentre.

We claim:

1. A method for controlling a functionality of an application in a hybrid deployment, the method comprising:
receiving, by a processor, an application developed utilizing an application archetype, wherein the application archetype enables abstraction of one or more complexities of developing the application, wherein the application archetype comprises one or more of build and package feature, a multi tenancy feature, a data access feature, a customization feature, a security feature, a user interface feature and a synchronization feature, wherein the application is developed by a developer;
deploying, by the processor, the application in a hybrid deployment, wherein the hybrid deployment comprises a cloud datacentre deployment and a local datacentre deployment;
obtaining, by the processor, primary configuration data associated with the cloud datacentre deployment and secondary configuration data associated with the local datacentre deployment, wherein the primary configuration data and the secondary configuration data is obtained dynamically at runtime from one or more users of the application, and wherein the primary configuration data and the secondary configuration data comprises one or more of a functionality, a write operation and a data synchronization;
storing, by the processor, the primary configuration data and the secondary configuration data as a metadata in the application; and
controlling, by the processor, one or more functionality of the application, at runtime, based on the metadata.

2. A method of claim 1, further comprises:
obtaining, by the processor, a user login data and a Uniform Resource Locator (URL) indicative of a functionality to be accessed;
determining, by the processor, a deployment type, wherein the deployment type comprises the cloud datacentre deployment and the local datacentre deployment;
checking, by the processor, an access to the functionality based on the metadata and the deployment type; and
denying, by the processor, the access to the functionality based on the checking.

3. A method of claim 1, wherein the data synchronization comprises synchronizing one or more of a functionality between the cloud datacentre deployment and the local datacentre deployment.

4. A system for controlling a functionality of an application in a hybrid deployment, the system comprising:
a memory; and
a processor coupled to the memory, wherein the processor is capable of executing instructions to perform steps of:
receiving an application developed utilizing an application archetype, wherein the application archetype enables abstraction of one or more complexities of developing the application, wherein the application archetype comprises one or more of a build and package feature; a multi tenancy feature, a data access feature, a customization feature, a security feature, a user interface feature and a synchronization feature wherein the application is developed by a developer;
deploying the application in a hybrid deployment, wherein the hybrid deployment comprises a cloud datacentre deployment and a local datacentre deployment;
obtaining primary configuration data associated with the cloud datacentre deployment and secondary configuration data associated with the local datacentre deployment wherein the primary configuration data and the secondary configuration data is obtained dynamically at runtime from one or more users of the application, and wherein the configuration data comprises one or more of a functionality, a write operation and a data synchronization;
storing the primary configuration data and the secondary configuration data as a metadata in the application archetype; and
controlling one or more functionality of the application, at runtime, based on metadata.

5. A system of claim 4, further comprises:
obtaining a user login data and a Uniform Resource Locator (URL) indicative of a functionality to be accessed;
determining a deployment type, wherein the deployment type comprises the cloud datacentre deployment and the local datacentre deployment;
checking an access to the functionality based on the metadata and the deployment type; and
denying the access to the functionality based on the checking.

6. A system of claim 4, wherein the data synchronization comprises synchronizing one or more of a functionality between the cloud datacentre deployment and the local datacentre deployment.

7. A non-transitory computer program product having embodied thereon a computer program for controlling a functionality of an application in a hybrid deployment, the computer program product storing instructions, the instructions comprising instructions for:
receiving an application developed utilizing an application archetype, wherein the application archetype enables abstraction of one or more complexities of developing the application, wherein the application archetype comprises one or more of build and package feature; a multi tenancy feature, a data access feature, a customization feature, a security feature, a user interface feature and a synchronization feature wherein the application is developed by a developer;
deploying the application in a hybrid deployment, wherein the hybrid deployment comprises a cloud datacentre deployment and a local datacentre deployment;
obtaining a primary configuration data associated with cloud datacentre deployment and the secondary configuration data associated with the local datacentre. wherein the primary configuration data and the secondary configuration data is obtained dynamically at runtime from one or more users of the application, and wherein the configuration data comprises one or more of a functionality, write operation and data synchronization;
storing the primary configuration data and the secondary configuration data as a metadata in the application archetype; and
controlling one or more functionality of the application, at runtime, based on metadata.
